(19) United States
(12) Patent Application Publication
(10) Pub. No.: US 2024/0196485 A1
(43) Pub. Date: Jun. 13, 2024

(54) INDUCTION HEATING COIL UNIT AND INDUCTION HEATING DEVICE

(71) Applicants: NGK INSULATORS, LTD., Nagoya-City (JP); NATIONAL UNIVERSITY CORPORATION OKAYAMA UNIVERSITY, Okayama-City (JP)

(72) Inventors: Kazuhiro UMETANI, Okayama-Shi (JP); Shota KAWAHARA, Okayama-Shi (JP); Daiki MIYAKE, Nagoya-Shi (JP); Masataka ISHIHARA, Okayama-Shi (JP); Eiji HIRAKI, Okayama-Shi (JP); Shuichi ICHIKAWA, Nagoya-Shi (JP); Yukio MIYAIRI, Nagoya-Shi (JP); Masaaki MASUDA, Nagoya-Shi (JP); Takuya ISHIHARA, Tsushima-Shi (JP)

(73) Assignees: NGK INSULATORS, LTD., Nagoya-City (JP); NATIONAL UNIVERSITY CORPORATION OKAYAMA UNIVERSITY, Okayama-City (JP)

(21) Appl. No.: 18/419,870

(22) Filed: Jan. 23, 2024

Related U.S. Application Data
(63) Continuation of application No. PCT/JP22/33028, filed on Sep. 1, 2022.

(30) Foreign Application Priority Data
Sep. 3, 2021 (JP) 2021-144275

(51) Int. Cl. H05B 6/36

(52) U.S. Cl. CPC H05B 6/36

(57) ABSTRACT

An induction heating coil unit 2 according to the present invention is an induction heating coil unit 2being configured to be able to heat a heating object 1 by induction heating, wherein the induction heating coil unit 2 includes: an induction heating coil 20 wherein conductors 200 are wound around a predetermined axis line AL; and end wall portions 21 made of a soft magnetic material, the end wall portions 21 being disposed to cover at least a part of end portions on both sides of the induction heating coil 20 in an axial direction, and wherein each of the conductors 200 has an opposing surface 201 opposing to an outer peripheral surface or an inner peripheral surface of the heating object 1, and wherein the opposing surface 201 includes a parallel portion 201a extending parallel to the axis line AL.

### FIELD OF THE INVENTION

The present invention relates to an induction heating coil unit and an induction heating device.

### BACKGROUND OF THE INVENTION

For example, as shown in Non-Patent Literature 1 below, induction heating is known to heat a heating object by electromagnetic induction. The induction heating is performed by placing an induction heating coil near a heating object containing magnetic and/or conductive materials and generating a magnetic field near the induction heating coil.

The induction heating coil can be formed by winding a conductor, such as a copper pipe and a rectangular wire, around a predetermined axis. For example, when heating a pillar shaped heating object, the induction heating coil can be placed around the outer periphery of the heating object. The magnetic field can be generated by passing an electric current through the induction heating coil. The current flowing through the induction heating coil can be a large current obtained by amplifying alternating current from a high-frequency inverter with a transformer. The induction heating is particularly useful for a heating material with poor thermal conductivity and for a heating object under conditions where thermal contact is not easy, because the induction heating can heat the heating object without any contact.

### CITATION LIST

### Non-Patent Literature

[Non-Patent Literature 1] JAPAN ELECTRO-HEAT CENTER (ed.), “Newly Revised Version: Electro-heat Handbook”, Ohmsha, Ltd., Apr. 10, 2019 (p. 263)

### SUMMARY OF THE INVENTION

In the induction heating coil as described above, the magnetic field generated by the induction heating coil to heat a heating object becomes extremely large at end portions of the induction heating coil, and the induction heating coil itself is extremely heated at those end portions. Therefore, the electric power supplied to the induction heating coil is wasted in generating heat at the end portions of the induction heating coil, resulting in a decreased heating efficiency of the heating object. Further, when the end portions of the induction heating coil generate abnormal heat, there is also a problem that it will be difficult to cool the induction heating coil.

The present invention was made to solve the above problems. An object of the present invention is to provide an induction heating coil unit and an induction heating device, which can suppress extreme heat generation at the end portions of the induction heating coil.

An induction heating coil unit according to an aspect of the present invention is an induction heating coil unit disposed around an outer periphery of a heating object or inserted into a hollow portion of the heating object, the induction heat coil unit being configured to be able to heat the heating object by induction heating, wherein the induction heating coil unit comprises: an induction heating coil wherein conductors are wound around a predetermined axis line; and end wall portions made of a soft magnetic material, the end wall portions being disposed to cover at least a part of end portions on both sides of the induction heating coil in an axial direction, and wherein each of the conductors has an opposing surface opposing to an outer peripheral surface or an inner peripheral surface of the heating object, and wherein the opposing surface comprises a parallel portion extending parallel to the axis line.

An induction heating coil unit according to another aspect of the present invention is an induction heating coil unit disposed around an outer periphery of a heating object or inserted into a hollow portion of the heating object, the induction heat coil unit being configured to be able to heat the heating object by induction heating, wherein the induction heating coil unit comprises: an induction heating coil wherein conductors corresponding to at least one of (i) conductors each having corners in a cross section and (ii) conductors each having a flat cross section are wound around a predetermined axis line; and end wall portions made of a soft magnetic material, the end wall portions being disposed so as to cover at least a part of end portions on both sides of the induction heating coil in an axial direction.

An induction heating device according to an aspect of the present invention comprises: the induction heating coil unit as described above; and a heating object wherein the induction heating coil unit is disposed on an outer periphery or inserted into an internal hollow portion of the heating object, the heating object being induction-heated by the induction heating coil unit.

According to an induction heating coil unit and an induction heating device of the present invention, it is possible to suppress extreme heat generation at the end portions of the induction heating coil.

### BRIEF DESCRIPTION OF THE DRAWINGS

FIG. 1 is a perspective view showing an induction heating device according to Embodiment 1 of the present invention;

FIG. 2 is a perspective view showing a variation of the induction heating device shown in FIG. 1;

FIG. 3 is a circuit diagram showing an example of the power supply circuit in FIG. 1;

FIGS. 4A-4B are explanatory views each showing a function of the end wall portion in FIG. 1;

FIGS. 5A-5B are explanatory views each showing a mode of an induction heating coil in an extending direction of an axis line;

FIG. 6 is an explanatory view showing a first mode of conductors of the induction heating coil in FIGS. 5A-5B;

FIG. 7 is an explanatory view showing a second mode of conductors of the induction heating coil in FIGS. 5A-5B;

FIG. 8 is an explanatory view showing a third mode of conductors of the induction heating coil in FIGS. 5A-5B;

FIG. 9 is an explanatory view showing a fourth mode of conductors of the induction heating coil in FIGS. 5A-5B;

FIG. 10 is an explanatory view showing a fifth mode of conductors of the induction heating coil in FIGS. 5A-5B;

FIGS. 11A-11B are explanatory views each showing a mode of an end wall portion in a direction orthogonal to an axis line;

FIGS. 12A-12C are explanatory views showing first to third modes of the end wall portion in FIGS. 11A-11B;

FIG. 13 is a perspective view showing an induction heating device according to Embodiment 2 of the present invention;

FIG. 14 is a cross-sectional view of the induction heating coil unit in FIG. 13;

FIG. 15 is a cross-sectional view of an induction heating coil unit in an induction heating device according to Embodiment 3 of the present invention;

FIG. 16 is a cross-sectional view of an induction heating coil unit in an induction heating device according to Embodiment 4 of the present invention;

FIG. 17 is a cross-sectional view of an induction heating coil unit in an induction heating device according to Embodiment 5 of the present invention;

FIGS. 18A-18C are explanatory views each showing an effect of a relative magnetic permeability of a soft magnetic material forming an end wall portion;

FIG. 19 is an explanatory view showing an analytical model for investigating the effect of the relative magnetic permeability of the soft magnetic material forming the end wall portion;

FIG. 20 is a graph showing a relationship between a resistance ratio of an induction heating coil and a relative magnetic permeability of a soft magnetic material forming an end wall portion;

FIGS. 21A-21C are explanatory views each showing an effect of a distance between an end portion of an induction heating coil and an end wall portion in an extending direction of an axis line;

FIG. 22 is an explanatory view showing an analytical model for investigating the effect of the distance between the end portion of the induction heating coil and the end wall portion in the extending direction of the axis line;

FIG. 23 is a graph showing a relationship between: a resistance ratio of an induction heating coil; and a distance ratio of a distance between an end portion and an end wall portion to a distance between an induction heating coil and a surface of a heating object;

FIGS. 24A-24C are explanatory views each showing an effect of a thickness of a conductor in a direction orthogonal to an axis line;

FIG. 25 is an explanatory view showing an analytical model for investigating the effect of the thickness of the conductor in the direction orthogonal to the axis line;

FIG. 26 is a graph showing a relationship between a resistance of an induction heating coil normalized by a minimum resistance value and a thickness of a conductor with respect to a skin depth of the conductor; and

FIG. 27 is a perspective view showing an example of a heating object 1 in FIG. 1.

### DETAILED DESCRIPTION OF THE INVENTION

Hereinafter, embodiments for carrying out the present invention will be described with reference to the drawings. The present invention is not limited to each embodiment, and components can be modified and embodied without departing from the spirit of the present invention. Further, various inventions can be formed by appropriately combining a plurality of components disclosed in each embodiment. For example, some components may be removed from all of the components shown in the embodiments. Furthermore, the components of different embodiments may be optionally combined.

### Embodiment 1

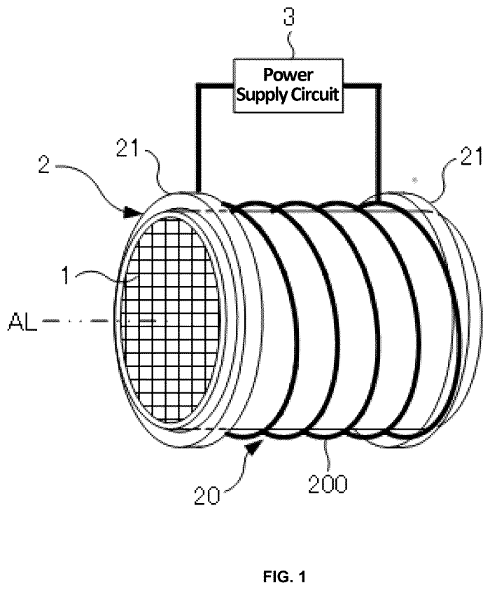

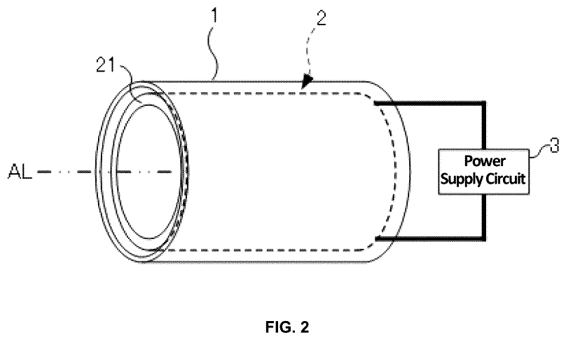

FIG. 1 shows an induction heating device including an induction heat coil unit 2 and a heating object 1, FIG. 2 is a perspective view showing a variation of the inductive heating device in FIG. 1. The induction heating device shown in FIG. 1 and FIG. 2 is a device configured to be able to heat the heating object 1 by induction heating. The induction heating device according to this embodiment has the heating object 1, an induction heating coil unit 2 and a power supply circuit 3.

The heating object 1 is a member containing a magnetic material and/or a conductive material. The magnetic material and/or the conductive material may form the whole or part of the heating object 1. The heating object 1 has any shape, and it may have a pillar shape as shown in FIG. 1 or may be a cylindrical member as shown in FIG. 2. The pillar shape is understandable as a three-dimensional shape having a predetermined thickness in the axial direction. The heating object 1 has any ratio (aspect ratio) between an axial length of the heating object 1 and a diameter or width of an end face of the heating object 1. The pillar shape may also include a shape (flat shape) in which the axial length of the heating object 1 is shorter than the diameter or width of the end face. The heating object 1 has any cross-sectional shape, and it may have a circular shape as shown in FIGS. 1 and 2, or may have other shapes such as a polygon.

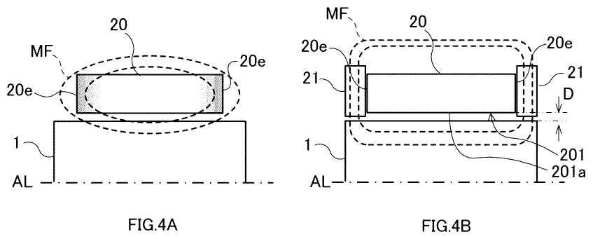

The induction heating coil unit 2 is a unit that is disposed around an outer periphery of the heating object 1 as shown in FIG. 1, or inserted into a hollow portion of the heating object 1 as shown in FIG. 2, and is configured to be able to heat the heating object 1 by induction heating. The induction heating coil unit 2 according to Embodiment 1 includes an induction heating coil 20 and end wall portions 21. The induction heating coil 20 has conductors 200 wound around a predetermined axis line AL. The axis line AL of the induction heating coil 20 may be parallel to the axial direction of the hating object 1. The axis line AL may be coaxial with the central axis of the heating object 1. The end wall portions 21 are wall portions made of a soft magnetic material, and are arranged so as to cover at least a part of end portions 20e (see FIGS. 4A-4B later) on both sides of the induction heating coil 20 in the axial direction. The induction heating coil 20 and the end wall portions 21 will be described below in detail.

A power supply circuit 3 is connected to the induction heating coil 20. By supplying alternating current from the power supply circuit 3 to the induction heating coil 20, an electric field is generated near the induction heating coil 20. The heating object 1 can be induction-heated by the electric field generated by the induction heating coil 20.

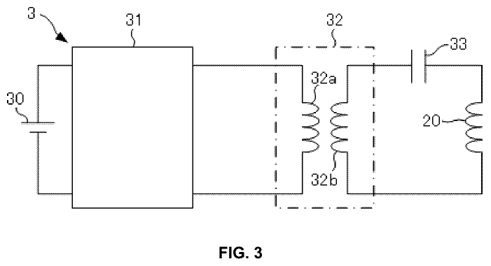

Next, FIG. 3 is a circuit diagram showing an example of the power supply circuit in FIG. 1. As shown in FIG. 3, the power supply circuit 3 can include a direct-current power supply 30; an inverter 31; a transformer 32; and a resonance capacitor 33. The direct-current power from the direct-current power supply 30 is converted into alternating-current power by the inverter 31. The transformer 32 has a primary coil 32a connected to the inverter 31 and a secondary coil 32b connected to the resonance capacitor 33 and to the induction heating coil 20. A ratio of the numbers of turns for the primary coil 32a and the secondary coil 32b is N:1. The symbol N is a number greater than 1, and the transformer 32 can amplify the current of the alternating-current power. The capacity of the resonance capacitor 33 is set so as to adjust the resonance frequency of the power supply circuit 3. The induction heating coil 20 can be connected in series to the resonance capacitor 33, and connected to both ends of the secondary coil 32b together with the resonance capacitor 33.

### Regarding Function of End Wall Portion 21

Next, FIGS. 4A-4B are explanatory views showing a function of the end wall portions 21 in FIG. 1. FIG. 4A shows a magnetic field when the end wall portions 21 are not provided, and FIG. 4B shows the magnetic field when the end wall portions 21 are provided. It should be noted that FIGS. 4A-4B show the cross section of the pillar shaped heating object 1, and the induction heating coil 20 arranged around its outer periphery, and the like. The cross section shown in FIGS. 4A-4B are a cross section of the heating object 1 and the like on one side in the radial direction or width direction of the heating object 1. FIGS. 4A-4B schematically show the induction heating coil 20. The present inventors consider that the extreme heat generation of the end portions 20e of the induction heating coil 20 is suppressed by arranging the end wall portions 21 made of the soft magnetic material so as to cover at least a part of the end portions 20e on both sides of the induction heating coil 20 in the axial direction, for the following reasons:

As described above, a magnetic flux MF is generated near the induction heating coil 20 by supplying the alternating current to the induction heating coil 20. If the end wall portions 21 are not provided as shown in FIG. 4A, the magnetic field due to the magnetic flux MF becomes extremely high at the end portions 20e on both sides of the induction heating coil 20 in the axial direction, so that the induction heating coil 20 itself may be extremely heated at those end portions 20e. On the other hand, as shown in FIG. 4B, the end wall portions 21 made of the soft magnetic material are arranged to cover at least a part of the end portions 20e on both sides of the induction heating coil 20 in the axial direction, so that the magnetic flux MF can be attracted to the end wall portions 21. This can lead to suppression of the magnetic field at the end portions 20e on both sides of the induction heating coil 20 in the axial direction, so that the extreme heat generation at the end portions 20e of the induction heating coil 20 can be suppressed. This function is the same in the case where the induction heating coil unit 2 is inserted into the hollow portion of the heating object 1 as shown in FIG. 2.

Each conductor 200 has an opposing surface 201 opposing to the outer peripheral surface of the heating object 1. When the induction heating coil 20 is inserted into the hollow portion of the heating object 1 as shown in FIG. 2, the opposing surface 201 is understandable as a surface opposing to the inner peripheral surface of the heating object 1. It is preferable that the opposing surface 201 includes a parallel portion 201a extending parallel to the axis line AL. The opposing surface 201 includes the parallel portion 201a, so that when the induction heating coil 20 is arranged such that the axis line AL of the induction heating coil 20 is parallel to the axial direction of the heating object 1, a variation in a distance D between the opposing surface 201 and the outer peripheral surface or the inner peripheral surface of the heating object 1 in the extending direction of the axis line AL can be suppressed. By suppressing the variation in the distance D, the magnetic field on the surface of the induction heating coil 20 opposing to the heating object 1 can be made more uniform, so that any local heat generation of the induction heating coil 20 can be suppressed. Further, the combination with the end wall portions 21 will lead to application of a uniform magnetic field to the entire induction heating coil 20 including the end portions 20e of the induction heating coil 20, so that all portions of the induction heating coil 20 uniformly generate heat. Therefore, it is possible to suppress an increase in the electrical resistance of the induction heating coil 20 due to heating.

### Details of Induction Heating Coil 20

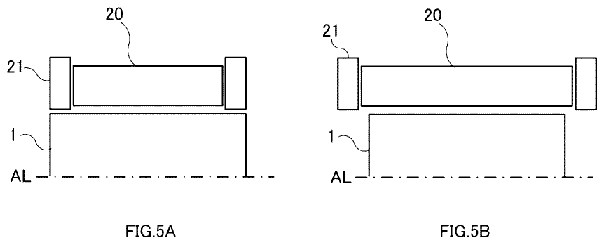

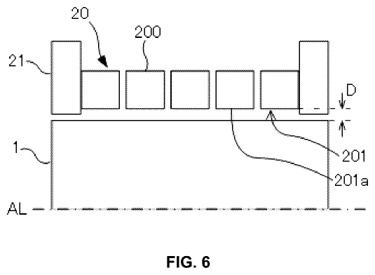

Next, the induction heating coil 20 will be described in more detail using FIGS. 5 to 10. FIGS. 5A-5B are explanatory views showing a mode of the induction heating coil 20 in the extending direction of the axis line AL. FIGS. 6 to 10 are explanatory views showing first to fifth modes of a conductor 200 of the induction heating coil 20 in FIGS. 5A-5B.

As shown in FIGS. 5A-5B, a length (axial length) of the induction heating coil 20 in the extending direction of the axis line AL (axial direction) can be optionally changed. The length of the induction heating coil 20 in the axial direction may be shorter than that of the heating object 1 in the axial direction as shown in FIG. 5A, or may be longer than that of the heating object 1 in the axial direction as shown in FIG. 5B. The central position of the induction heating coil 20 in the axial direction may be aligned with that of the heating object 1 in the axial direction, or may be shifted from the same position to one side in the axial direction.

As shown in FIGS. 6 to 9, the shape of the conductor 200 of the induction heating coil 20 can optionally be changed.

FIG. 6 shows an embodiment where the cross-sectional shape of the conductor 200 is square. When the cross-sectional shape of the conductor 200 is square, the entire opposing surface 201 can form the parallel portion 201a. As shown in FIG. 6, the conductors 200 may be wound so as to form one row in the extending direction of the axis line AL. All the conductors 200 may be connected in series to each other, or some conductors 200 may be connected in parallel to other conductors 200. Although the cross-sectional shape of the conductor 200 is shown as being solid in FIG. 6, the cross-sectional shape of the conductor 200 may be hollow (a square cylindrical shape). The number of rows in the extending direction of the axis line AL, their connection relationship, and whether they are solid or hollow are the same even for other cross-sectional shapes.

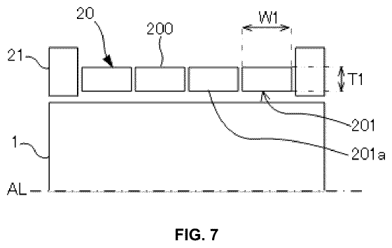

FIG. 7 shows an embodiment where the cross-sectional shape of the conductor 200 is rectangular. Such a conductor 200 may be referred to as a rectangular wire. When the cross-sectional shape of the conductor 200 is rectangular, the entire opposing surface 201 can form the parallel portion 201a.

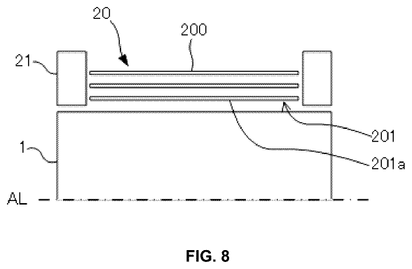

FIG. 8 shows an embodiment where each conductor 200 is in a thin sheet having a smaller thickness in the direction orthogonal to the axis line AL than the width in the extending direction of the axis line AL. Such a conductor 200 having the sheet shape may be referred to as a thin film. As shown in FIG. 8, the conductors 200 each having the sheet shape can be wound so as to be stacked in the direction orthogonal to the axis line AL. In other words, the conductors 200 each having the sheet shape are spirally wound around the axis line AL. The conductors 200 in all the stacks may be connected in series to each other, or the conductors 200 in some stacks may be connected in parallel to the conductors 200 in other stacks. The conductors 200 in each stack may be insulated from each other. When the conductors 200 each having the sheet shape are stacked, the conductor 200 located at the innermost or outermost periphery has the opposing surface 201. Further, the entire opposing surface 201 can form the parallel portion 201a.

As described above, in this embodiment, the end wall portions 21 suppress the magnetic field due to the magnetic flux MF of the end portions 20e. As a result, the magnetic flux MF is generated parallel to the inner surface of the coil. By stacking the sheet-shaped conductors 200, the conductors 200 can be made parallel to the magnetic flux MF, and the interlinking of the magnetic flux MF to the end portions 20e of the induction heating coil 20 can be suitably avoided, so that the extreme heat generation can be further reduced.

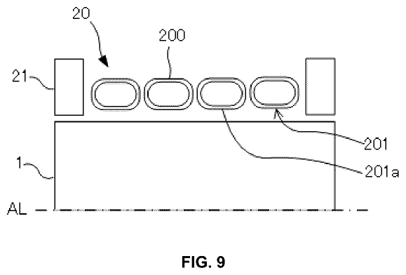

FIG. 9 shows an embodiment where the cross-sectional shape of each conductor 200 is substantially cylindrical. In other words, the cross-sectional shape of the conductor 200 is a track-shaped or oval-shaped cylinder (a shape having a pair of straight portions and a pair of curved lines connecting the end portions of the straight portions). This shape may be understandable as a rectangle with rounded corners. When the cross-sectional shape of the conductor 200 is substantially cylindrical, the straight portion included in the opposing surface 201 (a part of the opposing surface 201) can form the parallel portion 201a.

The function of the above opposing surface 201 including the parallel portion 201a is useful in any cross-sectional shape including the shapes shown in FIGS. 6 to 9.

Here, as described using FIG. 4A, when the end wall portions 21 are not provided, the magnetic field due to the magnetic flux MF becomes extremely large at the end portions 20e on both sides of the induction heating coil 20 in the axial direction, the induction heating coil 20 itself may be extremely heated at those end portions 20e. However, when the cross-sectional shape of the conductor 200 is a perfect circle, the cross-sectional shape of the conductor 200 is smooth, so that the magnetic field due to the magnetic flux MF is difficult to increase even at the end portions 20e on both sides in the axial direction. In other words, the problem that the magnetic field becomes extremely large at end portions 20e on both sides of the induction heating coil 20 in the axial direction would be remarkable when the cross-sectional shape of the conductor 200 is not a perfect circle and the opposing surface 201 includes the parallel portion 201a. That is, the arrangement of the end wall portions 21 made of the soft magnetic material so as to cover at least a part of the end portions 20e on both sides of the induction heating coil 20 in the axial direction would be a particularly useful configuration when the opposing surface 201 includes the parallel portion 201a.

Further, the problem that the magnetic field becomes extremely large at the end portions 20e on both sides of the induction heating coil 20 in the axial direction would also be remarkable when the cross-sectional shape of the conductor 200 is not a perfect circle, and the conductors 200 corresponding to at least one of: (i) the conductors 200 have a shape having corners in the cross section, and (ii) the conductors 200 each having a flat cross section are used. That is, the arrangement of the end wall portions 21 made of the soft magnetic material so as to cover at least a part of the end portions 20e on both sides of the induction heating coil 20 in the axial direction would be a useful configuration when the conductors 200 corresponding to at least one of: (i) the conductors 200 each having corner portions in the cross section; and (ii) the conductors 200 each having the flat cross section are used. In this case, the opposing surface 201 of each conductor 200 may or may not include the parallel portion 201a. The flat cross-sectional shape has a major axis diameter and a minor axis diameter (a straight line orthogonal to the major axis diameter) in the cross section. The ratio of the long axis diameter (L1) to the short axis diameter (S1) (L1/S1: aspect ratio) can optionally be changed, and it can be in the range of 2 or more and 100 or less, for example.

It should be noted that the conductors 200 each having the square cross-sectional shape shown in FIG. 6 correspond to (i) the conductors having the corner portions in the cross section. The conductors 200 each having the rectangular cross-section shown in FIG. 7 correspond to both (i) the conductors each having the corner portions in the cross section and (ii) the conductors each having the flat cross-sectional shape. The sheet-shaped conductors 200 shown in FIG. 8 correspond to at least (ii) the conductors each having the flat cross-sectional shape. When the corner portions can be confirmed in the cross-sectional shape, the sheet-shaped conductors 200 may be understood to correspond to (i) the conductors having the corner portions in the cross section. The conductors 200 each having the track-shaped or oval-shaped cross section shown in FIG. 9 correspond to (ii) the conductors each having the flat cross section. The cross-sectional shape of the conductor 200 may be elliptical. The ellipse also corresponds to the flat shape.

The total extending width of the parallel portions 201a in the extending direction of the axis line AL is preferably at least half the extending width of the induction heating coil 20 in the extending direction of the axis line AL. For example, when the entire opposing surface 201 forms the parallel portion 201a as in each conductor 200 having the rectangular cross-sectional shape as shown in FIG. 6, the total extending width of the parallel portions 201a corresponds to a value obtained by subtracting the separation width between the conductors 200 from the extending width of the induction heating coil 20. On the other hand, when a part of the opposing surface 201 forms the parallel portion 201a as in each conductor 200 having track-shaped or oval-shaped cross section as shown in FIG. 9, the total extending width of the parallel portions 201a corresponds to a value obtained by adding the extending width of the part forming the parallel portion 201a (the extending width of the straight portion included in the opposing surface 201). The extending width of the induction heating coil 20 can a distance between the outer ends of the induction heating coil 20 in the extending direction of the axis line AL. The total extending width of the parallel portions 201a is at least half of the extending width of the induction heating coil 20, so that the magnetic field on the surface of the induction heating coil 20 opposing to the heating object 1 can be made more reliably uniform, and any local heat generation of the induction heating coil 20 can be suppressed.

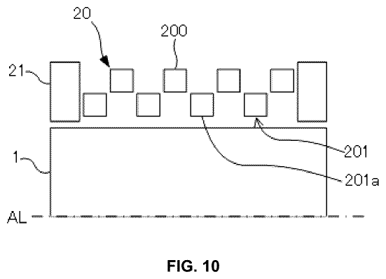

It should be noted that, as shown in FIG. 10, the conductors 200 may be wound in a plurality of rows in the extending direction of the axis line AL. FIG. 10 shows a mode where the conductors 200 each having the square cross section are wound in two rows in the extending direction of the axis line AL. Even in such a mode, all the conductors 200 may be connected in series to each other, or some conductors 200 may be connected in parallel to other conductors 200. Moreover, the conductors 200 having different cross-sectional shapes may be wound in a plurality of rows in the extending direction of the axis line AL.

### Details of End Wall Portion 21

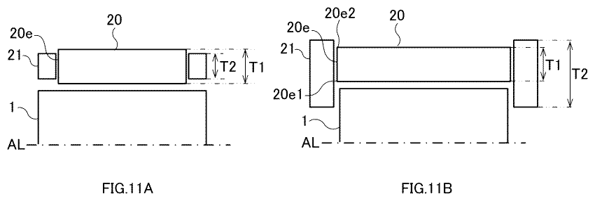

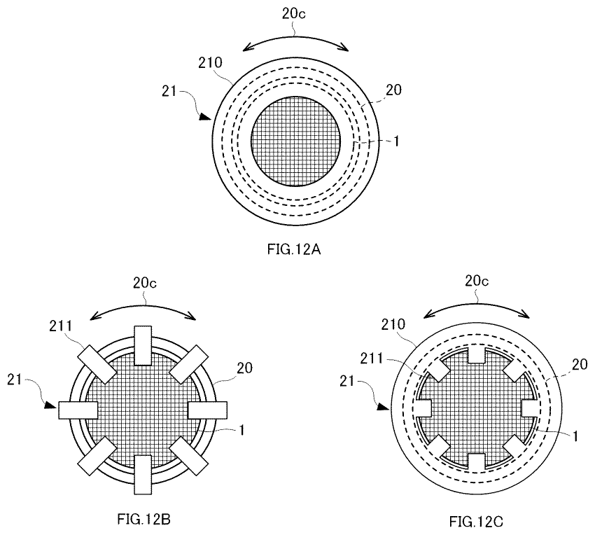

Next, the end wall portions 21 will be described in more detail using FIGS. 11 and 12. FIGS. 11A-11B are explanatory views showing a mode of the end wall portions 21 in a direction orthogonal to the axis line AL. FIGS. 12A-12C are explanatory views showing first to third modes of the end wall portions 21 in FIGS. 11A-11B. FIGS. 12A-12C are also a front view showing the end wall portions 21 as viewed along the axis line AL.

As shown in FIGS. 11A-11B, a thickness (T2) of each end wall portion 21 in the direction orthogonal to the axis line AL can optionally be changed. The thickness (T2) of each end wall portion 21 may be thinner than a thickness (T1) of each conductor 200 in the direction orthogonal to the axis line AL as shown in FIG. 11A, or may be thicker than the thickness (T1) of each conductor 200 as shown in FIG. 11B.

When the thickness (T2) of each end wall portion 21 is thinner than the thickness (T1) of each conductor 200 as shown in FIG. 11A, the end wall portions 21 cover only a part of the end portions 20e on both sides of the induction heating coil 20 in the axial direction. In such a mode, any extreme heat generation at the end portions 20e of the induction heating coil 20 can be suppressed while reducing the amount of the material required for the end wall portions 21.

On the other hand, when the thickness (T2) of each end wall portion 21 is thicker than the thickness (T1) of each conductor 200 as shown in FIG. 11B, the end wall portions 21 can cover all of the end portions 20e on both sides of the induction heating coil in the axial direction. In such a mode, any extreme heat generation at the end portions 20e of the induction heating coil 20 can be more reliably suppressed. In particular, it is preferable that each end wall portion 21 protrudes from an inner edge 20e1 and an outer edge 20e2 of each end portion 20e in the direction orthogonal to the axis line AL, as shown in FIG. 11B. Such a mode can further reliably suppress the extreme heat generation at the end portions 20e of the induction heating coil 20. As shown in FIG. 11B, the end wall portions 21 may be provided so as to cover not only the end portions 20e of the induction heating coil 20 but also the end surface of the heating object 1.

As shown in FIGS. 12A-12C, the shape of each end wall portion 21 can optionally be changed. As shown in FIG. 12A, each end wall portion 21 may have an annular wall 210 that annularly extends over the entire circumferential direction 20c of the induction heating coil 20. The annular walls 210 can cover all of the end portions 20e on both sides of the induction heating coil in the axial direction. In such a mode, any extreme heat generation at the end portions 20e of the induction heating coil 20 can be more reliably suppressed.

As shown in FIG. 12B, each end wall portion 21 may have a plurality of spaced walls 211 spaced apart from each other in a circumferential direction 20c of the induction heating coil 20. The spaced walls 211 cover only a part of the end portions 20e on both sides of the induction heating coil 20 in the axial direction. In such a mode, any extreme heat generation at the end portions 20e of the induction heating coil 20 can be suppressed while reducing the amount of the material required for the end wall portions 21.

As shown in FIG. 12C, each end wall portion 21 may have both the annular wall 210 and the spaced walls 211. In such a mode, any extreme heat generation at the end portions 20e of the induction heating coil 20 can be more reliably suppressed. Although FIG. 12C shows the mode where each spaced wall 211 protrudes inwardly from the inner edge of the annular wall 210, each spaced wall 211 may protrude outwardly from the outer edge of the annular wall 210.

Although FIGS. 12A-12C show each mode where the thickness (T2) of each end wall portion 21 is thicker than the thickness (T1) of each conductor 200 as in FIG. 11B, the end wall portion 21 may include at least one of the annular wall 210 and the spaced wall 211 even if the thickness (T2) of each end wall portion 21 is thinner than the thickness (T1) of each conductor 200 as shown in FIG. 11A.

### Embodiment 2

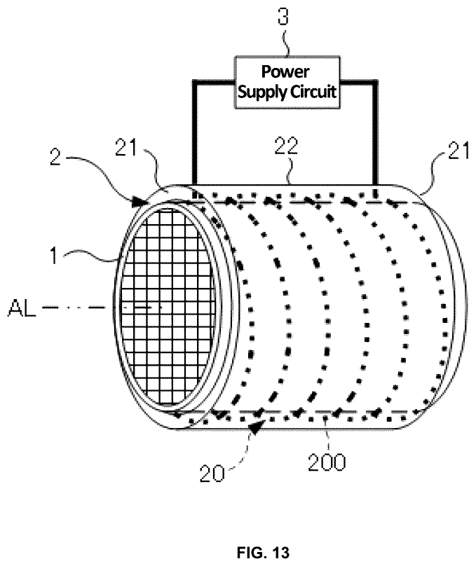

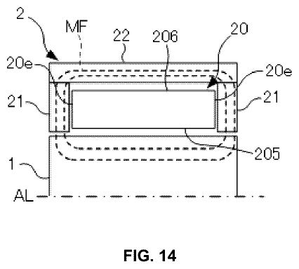

FIG. 13 is a perspective view showing an induction heating device according to Embodiment 2 of the present invention, and FIG. 14 is a cross-sectional view of an induction heating coil unit 2 in FIG. 13. The cross section shown in FIG. 14 is a cross section of the heating object 1 and the like on one side in the radial direction or width direction of the heating object 1. In FIG. 14, the induction heating coil 20 is schematically shown.

As particularly shown in FIG. 14, the induction heating coil 20 includes an opposing portion 205 opposing to the outer peripheral surface of the heating object 1, and a back portion 206 located on the opposite side of the opposing portion 205 in the direction orthogonal to the axis line AL. In this case, the back portion 206 is located on an outer side of the opposing portion 205 in the direction orthogonal to the axis line AL. As shown in FIG. 2, when the induction heating coil 20 is inserted into the hollow portion of the heating object 1, the opposing portion 205 is understandable as a portion opposing to the inner peripheral surface of the heating object 1. In this case, the back portion 206 is located on an inner side of the opposing portion 205 in the direction orthogonal to the axis line AL.

As shown in FIGS. 13 and 14, in addition to the configuration of Embodiment 1, the induction heating device according to Embodiment 2 further includes a back wall 22 made of a soft magnetic material, which is disposed so as to cover at least a part of the back portion 206 of the induction heating coil 200. By covering the back portion 206 with the back wall 22, the magnetic field due to the magnetic flux MF of the back portion 206 can be further reduced, and any extreme heat generation at the end portions 20e of the induction heating coil 20 can be further suppressed, and the heat generation of the induction heating coil 20 in the back portion 206 can be further suppressed. In addition, FIG. 13 illustrates that the back wall 22 covers the entire back portion 206 in the circumferential direction 20c of the induction heating coil 20 and in the extending direction of the axis line AL. However, the back wall 22 may be configured to cover only a part of the back portion 206 in the circumferential direction 20c of the induction heating coil 20 or in the extending direction of the axis line AL. The other configurations are the same as those of Embodiment 1.

### Embodiment 3

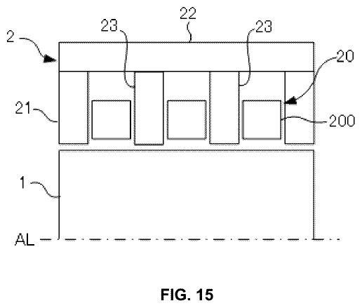

FIG. 15 is a cross sectional view of an induction heating coil unit 2 in an induction heating device according to Embodiment 3 of the present invention. As shown in FIG. 15, the conductors 200 of the induction heating coil 20 may be wound at intervals in the extending direction of the axis line AL.

The induction heating coil unit 2 according to Embodiment 3 further includes a plurality of first intermediate walls 23 made of a soft magnetic material, which are spaced apart from each other in the extending direction of the axis line AL so as to be located between the conductors 200 and which extend in the direction orthogonal to the axis line AL. The first intermediate walls 23 may be connected to the back wall 22. The magnetic flux MF generated inside the induction heating coil 20 can be reliably generated parallel to the inner surface of the induction heating coil 20. This allows the magnetic field caused by the magnetic flux MF to be made more uniform, so that any extreme heat generation at the end portions 20e of the induction heating coil 20 can be further reduced, as well as any local heat generation in the entire induction heating coil unit 2 can also be suppressed. The other configurations are the same as those of Embodiment 1.

### Embodiment 4

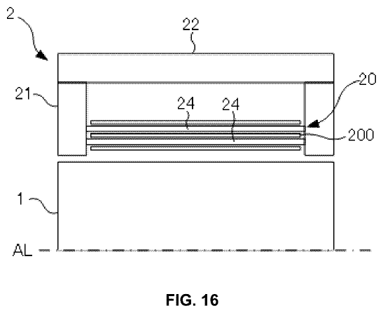

FIG. 16 is a cross-sectional view of an induction heating coil unit 2 in an induction heating device according to Embodiment 4 of the present invention. As shown in FIG. 16, the conductors 200 of the induction heating coil 20 may be wound at intervals in the direction orthogonal to the axis line AL. As with the embodiment shown in FIG. 8, each conductor 200 in FIG. 16 is a sheet-shaped conductor that has a thinner thickness in the direction orthogonal to the axis line AL than the width in the extending direction of the axis line AL, and it is wound so as to be stacked in the direction orthogonal to the axis line AL.

The induction heating coil unit 2 according to Embodiment 4 further includes a plurality of second intermediate walls 24 made of a soft magnetic material, which are spaced apart from each other in the direction orthogonal to the axis line AL so as to be located between the conductors 200 and which extend in the extending direction of the axis line AL. The second intermediate walls 24 may be connected to the end wall portions 21 or may be provided separately from the end wall portions 21. By reducing the magnetic field caused by the magnetic flux MF passing through the surface of the conductors 200 using the soft magnetic material, any extreme heat generation at the end portions 20e of the induction heating coil 20 can be further suppressed. The other configurations are the same as those of Embodiment 1.

### Embodiment 5

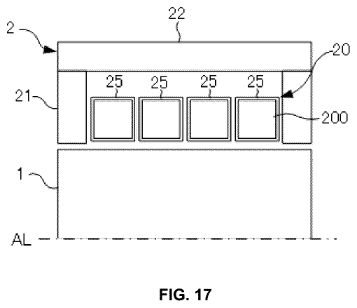

FIG. 17 is a cross-sectional view of an induction heating coil unit 2 in an induction heating device according to Embodiment 5 of the present invention. As shown in FIG. 17, the surfaces of the conductors 200 of the induction heating coil 20 may be covered with soft magnetic materials 25. The soft magnetic materials 25 may cover the entire surface of the conductors 200 in the extending direction and circumferential direction, or may cover a part of the surfaces. By reducing the magnetic field caused by the magnetic flux MF passing through the surfaces of the conductors 200 using the soft magnetic materials, any extreme heat generation at the end portions 20e of the induction heating coil 20 can be further suppressed. The other configurations are the same as those of Embodiment 1.

### Regarding Suitable Numerical Range for Each Feature

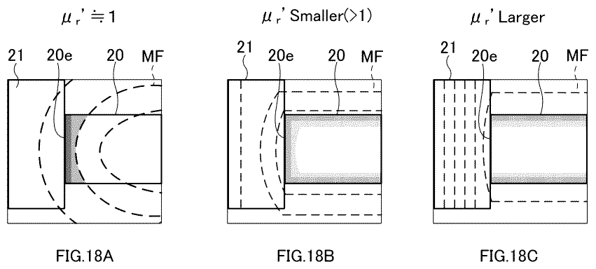

Next, a suitable numerical range for each feature will be described. FIGS. 18A-18C are explanatory views showing an effect of a relative magnetic permeability μᵣ′ of the soft magnetic material making up the end wall portion 21. FIG. 18A shows the magnetic flux MF around the end portions 20e of the induction heating coil 20 when the relative magnetic permeability μᵣ′ of the soft magnetic material making up the end wall portion 21 is about 1, and FIG. 18B shows a state of the magnetic flux MF when the relative magnetic permeability μᵣ′ is larger than FIG. 18A, and FIG. 18C shows a state of the magnetic flux MF when the relative magnetic permeability μᵣ′ is larger than FIG. 18B.

As shown in FIG. 18A, when the relative magnetic permeability μᵣ′ (a ratio of the magnetic permeability μ of the soft magnetic material to a magnetic permeability μ₀ in vacuum) of the soft magnetic material making up the end wall portion 21 is about 1, the magnetic permeability μ of the soft magnetic material is on the same level with the magnetic permeability of the surrounding air, and an amount of the magnetic flux MF attracted by the end wall portions 21 is smaller. As shown in FIGS. 18B-18C, as the relative magnetic permeability μᵣ′ of the soft magnetic material making up the end wall portion 21 increases, the end wall portion 21 can attract a larger amount of magnetic flux MF. Therefore, current variations at the end portions 20e of the induction heating coil 20 can be reduced. The current is distributed on the surfaces of the end portions 20e along the neighboring magnetic flux.

The present inventors have set an analytical model for the induction heating device on electromagnetic field analysis software, and a resistance ratio of the induction heating coil 20 (AC resistance R_{ac}/DC resistance R_{dc}) has been calculated while changing the relative magnetic permeability μᵣ′ of the soft magnetic material making up the end wall portion 21.

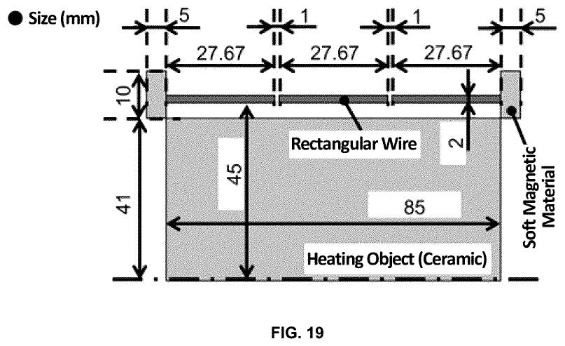

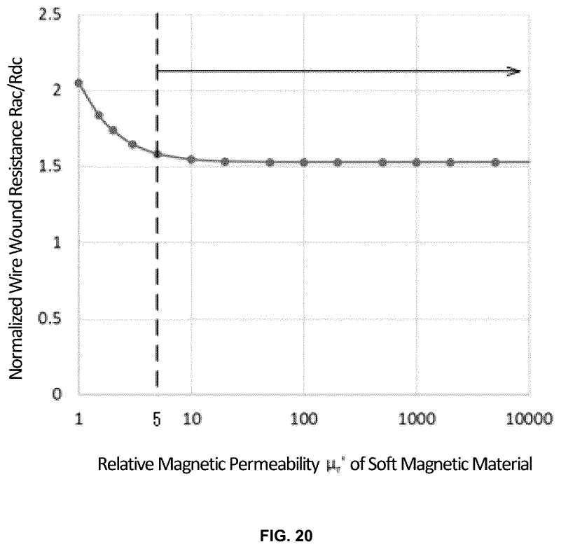

As the electromagnetic field analysis software, “JMAG-Designer 19.1” manufactured by JSOL Co., Ltd. was used. The analytical model set was a model in which the induction heating coil unit 2 having the induction heating coil 20 obtained by winding a rectangular copper wire (conductors 200 each having the rectangular cross section as shown in FIG. 7) was placed around the outer periphery of the heating object 1 (heating target), as shown in FIG. 19. The heating object 1 was a ceramic pillar shaped member (relative magnetic permeability: 1.1, conductivity: 0 S/m). The physical properties of the rectangular wire were set as relative magnetic permeability: 1.0 and resistivity: 1.67 Ωm (room temperature). The relative magnetic permeability μᵣ′ of the soft magnetic material making up the end wall portion 21 was variable, and the conductivity of the soft magnetic material was 0 S/m. The dimensions of each portion of the analytical model are as shown in FIG. 19. A set current with a frequency of 500 kHz and an amplitude (effective value) of 333 Arms was set to flow through the rectangular wire. The analysis conditions used were “two-dimensional_axial symmetry_frequency response analysis”. The results are shown in FIG. 20.

FIG. 20 is a graph showing a relationship between a resistance ratio (normalized wire wound resistance, AC resistance R_{ac}/DC resistance R_{dc}) of the induction heating coil 20 and the relative magnetic permeability μᵣ′ of the soft magnetic material making up the end wall portion 21. As shown in FIG. 20, it was confirmed that when the relative magnetic permeability μᵣ′ of the soft magnetic material making up the end wall portion 21 was 5 or more, the resistance ratio (AC resistance R_{ac}/DC resistance R_{dc}) of the induction heating coil 20 could be more reliably reduced. In view of the results, it is preferable that the relative magnetic permeability μᵣ′ of the soft magnetic material making up the end wall portion 21 is 5 or more. However, even if the relative magnetic permeability μᵣ′ is less than 5, the resistance ratio of the induction heating coil 20 may be reduced. Therefore, it is not excluded that the relative magnetic permeability μᵣ′ may be less than 5 depending on the implementation conditions. It should be noted that the upper limit value of the relative magnetic permeability μᵣ′ is not particularly limited from the viewpoint of the control of the resistance ratio, but from the viewpoint of industrial use, 10,000 is a standard value.

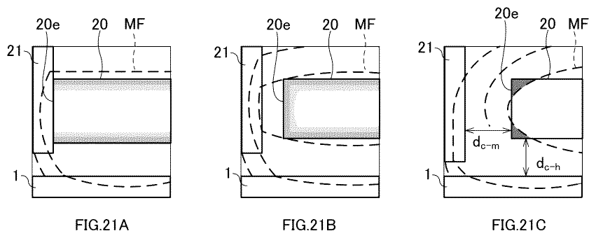

Next, FIGS. 21A-21C are explanatory views showing an effect of a distance between the end portion 20e of the induction heating coil 20 and the end wall portion 21 in the extending direction of the axis line AL. FIG. 21A shows a state of the magnetic flux MF around the end portion 20e of the induction heating coil 20 when the end portion 20e is in contact with the end wall portion 21, and FIGS. 21B-21C show a state of the magnetic flux MF when the end portion 20e is gradually separated from the end wall portion 21.

As shown in FIGS. 21A-21C, a smaller distance d_{c-m} (see FIG. 21C) between the end portion 20e and the end wall portion 21 attracts more magnetic flux MF, so that the current variations at the end portions 20e of the induction heating coil 20 can be reduced.

The present inventors set an analytical model of the induction heating device on electromagnetic field analysis software, and the resistance ratio of the induction heating coil 20 (AC resistance R_{ac}/DC resistance R_{dc}) was calculated while changing the distance d_{c-m} between the end portion 20e and the end wall portion 21.

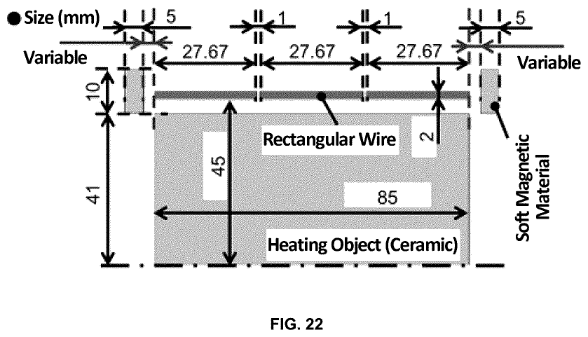

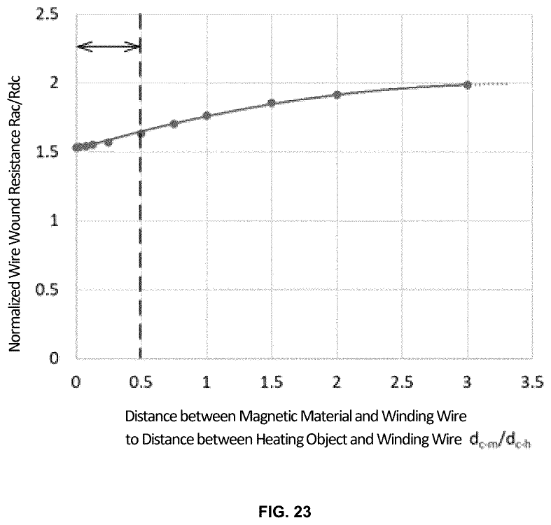

As the electromagnetic field analysis software, “JMAG-Designer 19.1” manufactured by JSOL Co., Ltd. was used. The analytical model set was a model in which the induction heating coil unit 2 having the induction heating coil 20 obtained by winding a rectangular copper wire (conductors 200 each having the rectangular cross section as shown in FIG. 7) was placed around the outer periphery of the heating object 1 (heating target), as shown in FIG. 22. The heating object 1 was a ceramic pillar shaped member (relative magnetic permeability: 1.1, conductivity: 0 S/m). The physical properties of the rectangular wire were set as relative magnetic permeability: 1.0 and resistivity: 1.67 Ωm (room temperature). For the relative magnetic permeability μᵣ′ and the conductivity of the soft magnetic material making up the end wall portion 21, nonlinear data in “JMAG” were used. The dimensions of each portion of the analytical model are as shown in FIG. 22. The distance d_{c-m} between the end portion 20e and the end wall portion 21 is variable. A set current with a frequency of 500 kHz and an amplitude (effective value) of 333 Arms was set to flow through the rectangular wire. The analysis conditions used were “two-dimensional_axial symmetry_frequency response analysis”. The results are shown in FIG. 23.

FIG. 23 is a graph showing a relationship between: a resistance ratio (normalized wire wound resistance, AC resistance R_{ac}/DC resistance R_{dc}) of the induction heating coil 20; and a distance ratio (a distance between the magnetic material and the winding wire relative to a distance between the heating object and the winding wire) d_{c-m}/d_{c-h} of a distance d_{c-m} between the end portion 20e and the end wall portion 21 to a distance d_{c-h} between the induction heating coil 20 and the surface of the heating object 1. As shown in FIG. 23, it was confirmed that the resistance ratio (AC resistance R_{ac}/DC resistance R_{dc}) of the induction heating coil 20 can be more reliably reduced when the distance ratio d_{c-m}/d_{c-h} is 0.5 or less. In view of the results, it was found that the distance d_{c-m} between the end portion 20e of the induction heating coil 20 and the end wall portion 21 in the extending direction of the axis line AL is less than or equal to 0.5 times the distance d_{c-h} between the induction heating coil 20 and the heating object in the direction orthogonal to the axis line AL. However, the resistance ratio of the induction heating coil 20 may be reduced even if the distance d_{c-m} is greater than 0.5 times the distance d_{c-h}.

Therefore, depending on the implementation conditions, it is not excluded that the distance d_{c-m} is more than or equal to 0.5 times the distance d_{c-h}.

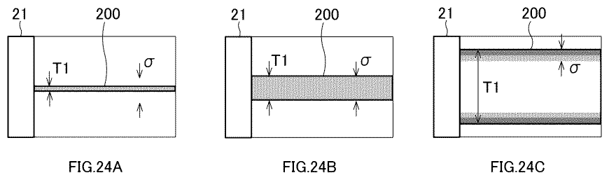

Next, FIGS. 24A-24C are explanatory views showing an effect of the thickness T1 of each conductor 200 in the direction orthogonal to the axis line AL. FIG. 24A shows a current distribution in each conductor 200 when the thickness T1 of each conductor 200 in the direction orthogonal to the axis line AL is thinner than a skin depth σ of each conductor 200, and FIG. 24B shows a current distribution in the conductor 200 when the thickness T1 of each conductor 200 is substantially the same as the skin depthσof each conductor 200, and FIG. 24C shows a current distribution in the conductor 200 when the thickness T1 of each conductor 200 is thicker than the skin depth σ of each conductor 200.

As shown in FIG. 24A, when the thickness T1 of each conductor 200 is thinner than the skin depth σ of each conductor 200, the current flows uniformly through the conductors 200. However, if the thickness T1 is thinner than the skin depth σ,the electrical resistance of each conductor 200 would increase.

As shown in FIG. 24B, when the thickness T1 of each conductor 200 is substantially the same as the skin depth σ of each conductor 200, the current flows uniformly through the conductors 200. Further, when the thickness T1 is substantially the same as the skin depth σ,the electrical resistance of each conductor 200 would also be an appropriate value.

As shown in FIG. 24C, when the thickness T1 of each conductor 200 is thicker than the skin depth σ of each conductor 200, the current would concentratedly flow over the surfaces of the conductors 200, and the electrical resistance of each conductor 200 would increase.

The present inventors set an analytical model of the induction heating device on electromagnetic field analysis software, and the AC resistance R_{ac} of the induction heating coil 20 was calculated while changing the thickness T1 (T1/σ) of each conductor 200 with respect to the skin depth σ of each conductor 200.

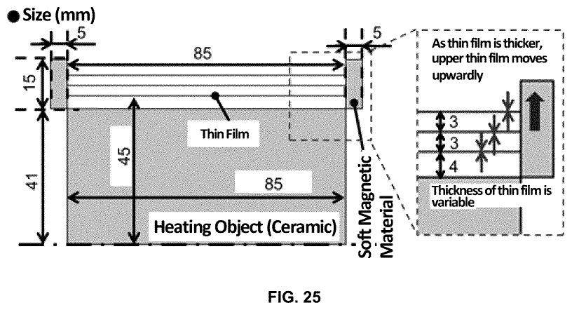

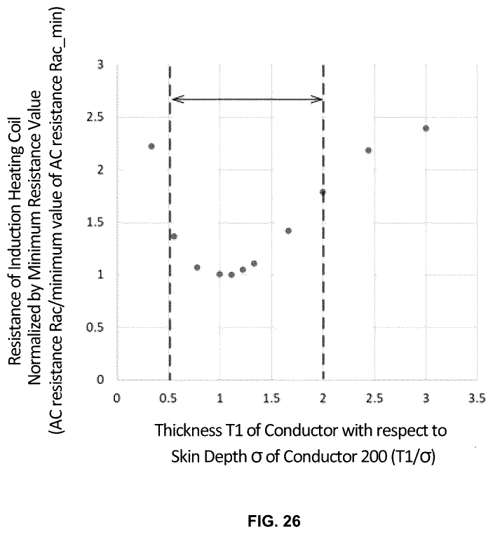

As the electromagnetic field analysis software, “JMAG-Designer 19.1” manufactured by JSOL Co., Ltd. was used. The analytical model set was a model in which the induction heating coil unit 2 having the induction heating coil 20 obtained by winding a copper thin film (conductors 200 each having a thin sheet shape as shown in FIG. 8) was placed around the outer periphery of the heating object 1 (heating target), as shown in FIG. 25. The heating object 1 was a ceramic pillar shaped member (relative magnetic permeability: 1.1, conductivity: 0 S/m). The physical properties of the thin film were set as relative magnetic permeability: 1.0 and resistivity: 1.67 Ωm (room temperature). For the relative magnetic permeability μᵣ′ and the conductivity of the soft magnetic material making up the end wall portion 21, nonlinear data in “JMAG” were used. The dimensions of each portion of the analytical model are as shown in FIG. 25. The thickness of the thin film is variable. The space between the thin films was fixed, and was set so that as the thickness of the thin film increased, the thickness of the induction heating coil 20 increased (as the thin film is thicker, the upper thin film was moved upwardly). A set current with a frequency of 500 kHz and an amplitude (effective value) of 333 Arms was set to flow through the thin films. The analysis conditions used were “two-dimensional_axial symmetry_frequency response analysis”. The results are shown in FIG. 26.

FIG. 26 a graph showing a relationship between a resistance of the induction heating coil 20 (AC resistance R_{ac}/minimum value of AC resistance R_{ac_min}) normalized by the minimum resistance value and the thickness T1 of each conductor 200 with respect to the skin depth σ of each conductor 200 (T1/σ). As shown in FIG. 26, it was found that when the thickness T1 of each conductor 200 in the direction orthogonal to the axis line AL is more than or equal to 0.5 times and less than or equal to twice the skin depth σ of each conductor 200, the resistance of the induction heating coil 20 can be more reliably reduced. In view of the results, it is preferable that the thickness T1 of each conductor 200 in the direction orthogonal to the axis line AL is more than or equal to 0.5 times and less than or equal to twice the skin depth σ of each conductor 200.

However, even if the thickness T1 is less than 0.5 times or more than twice the skin depth σ, the resistance ratio of the induction heating coil 20 may be reduced. Therefore, it is not excluded that the thickness T1 may be less than 0.5 times or more than twice the skin depth σ depending on the implementation conditions. In particular, when the thickness T1 is more than twice the skin depth σ, the resistance of the induction heating coil 20 cannot be reduced so much, which may be unique to the embodiment where the thin films are laminated. That is, when the thin films are laminated, the inner thin film is easily heated due to the effect of induction heating by the outer thin film, and an increase in electrical resistance of the conductor 200 is larger when the current concentratedly flows over the surfaces of the conductors 200. In cases other than the embodiment where the thin films are laminated, it is not very important that the thickness T1 of each conductor 200 in the direction orthogonal to the axis line AL satisfies the upper limit of twice the skin depth σ of each conductor 200, and the thickness T1 may be 0.5 times or more the skin depth σ.

### Regarding Example of Heating Object 1

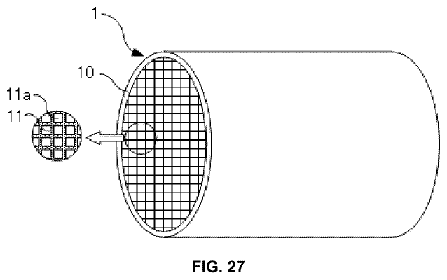

Next, FIG. 27 is a perspective view showing an example of the heating object 1 in FIG. 1. As shown in FIG. 27, the heating object 1 is a pillar shaped honeycomb structure including a honeycomb structure portion having an outer peripheral wall 10 and a partition wall 11 disposed on an inner side of the outer peripheral wall 10, the partition wall 11 defining a plurality of cells 11a each extending from one end face to other end face to form a flow path. When the heating object 1 is the honeycomb structure, the axial direction of the heating object 1 may be the extending direction of the cells 11a. The honeycomb structure may be, for example, a catalyst support for supporting a catalyst for purifying an exhaust gas from a vehicle or the like. The honeycomb structure may be housed in a metal can body (not shown). The can body can house the induction heating coil unit 2 together with the heating object 1.

The materials of the outer peripheral wall 10 and the partition wall 11 are not limited, but they are typically formed of ceramic materials. Examples of the ceramics include cordierite, silicon carbide, aluminum titanate, silicon nitride, mullite, alumina, silicon-silicon carbide-based composite materials, silicon carbide-cordierite-based composite materials, especially a sintered body mainly based on silicon-silicon carbide composite material or silicon carbide. As used herein, “silicon carbide-based” means that the outer peripheral wall 10 and the partition wall 11 contain 50% by mass of silicon carbide based on the total of the outer peripheral wall 10 and the partition wall 11. The phrase “the outer peripheral wall 10 and the partition wall 11 are mainly based on silicon-silicon carbide composite material” means that the outer peripheral wall 10 and the partition wall 11 contain 90% by mass of more of silicon-silicon carbide composite material (total mass) based on the total of the outer peripheral wall 10 and the partition wall 11. Here, for the silicon-silicon carbide composite material, it contains silicon carbide particles as an aggregate and silicon as a binding material to bind the silicon carbide particles, and preferably a plurality of silicon carbide particles are bound by silicon such that pores are formed between the silicon carbide particles. The phrase “the outer peripheral wall 10 and the partition wall 11 are mainly based on silicon carbide” means that the outer peripheral wall 10 and the partition wall 11 contain 90% or more of silicon carbide (total mass) based on the total of the outer peripheral wall 10 and the partition wall 11.

Preferably, the outer peripheral wall 10 and the partition wall 11 are made of at least one ceramic material selected from the group consisting of cordierite, silicon carbide, aluminum titanate, silicon nitride, mullite, and alumina.

The cell shape of the honeycomb structure is not particularly limited, but it may preferably be polygonal such as triangular, quadrangular, pentagonal, hexagonal, and octagonal, circular, or oval, in the cross section orthogonal to the central axis of honeycomb structure, or it may be irregularly shaped. Preferably, it is polygonal.

The thickness of the partition wall 11 of the honeycomb structure is preferably 0.05 to 0.50 mm, and more preferably 0.10 to 0.45 mm, in terms of ease of production. For example, when it is 0.05 mm or more, the strength of the honeycomb structure can be further improved, and when it is 0.50 mm or less, pressure loss can be reduced. The thickness of the partition wall 11 is an average value measured by microscopic observation of the cross section in the central axis direction.

The partition wall 11 preferably have a porosity of 20 to 70%. The porosity of the partition wall 11 is preferably 20% or more in terms of ease of production, and when it is 70% or less, the strength of the honeycomb structure can be maintained.

The partition wall 11 preferably have an average pore diameter of 2 to 30 μm, and more preferably 5 to 25 μm. The average pore diameter of the partition wall 11 of 2 μm or more leads to easy production, and the average pore diameter of 30 μm or less allows the strength of the honeycomb structure to be maintained. As used herein, the terms “average pore diameter” and “porosity” mean an average pore diameter and porosity measured by mercury intrusion technique.

The cell density of the honeycomb structure is not particularly limited, but it may preferably be in the range of 5 to 150 cells/cm², and more preferably in the range of 5 to 100 cells/cm², and even more preferably in the range of 31 to 80 cells/cm².

The outer shape of the honeycomb structure may be, but not limited to, a pillar shape having circular end faces (cylindrical shape), a pillar shape having oval end faces, and a pillar shape having polygonal (rectangular, pentagonal, hexagonal, heptagonal, octagonal, etc.) end faces.

The honeycomb structure is produced by forming a green body containing ceramic raw materials into a honeycomb shape having a partition wall extending from one end face to the other to form a plurality of cells that serve as fluid flow paths to form a honeycomb formed body, and then firing the honeycomb formed body after drying it. When the resulting honeycomb structure is used for the honeycomb structure, the outer peripheral wall may be extruded integrally with the honeycomb structure and used as it is as the outer peripheral wall, or the outer periphery of the honeycomb structure may be ground to a predetermined shape after forming or firing, and the honeycomb structure from which the outer periphery has been ground is coated with a coating material to form an outer peripheral coating. In this embodiment, for example, the honeycomb structure with the outer periphery may be used without grinding the outermost periphery of the honeycomb structure, and the outer peripheral surface of the honeycomb structure with that outer periphery (i.e., further outer side of the outer periphery of the honeycomb structure) may be further coated with the above coating material to form an outer peripheral coating. The former case will result in an outer peripheral wall in which only the outer peripheral coating comprised of the coating material is located in the outermost periphery for the outer peripheral surface of the honeycomb structure. On the other hand, the latter case will result in formation of a two-layered outer peripheral wall which is located in the outermost periphery and in which the outer peripheral coating consisting of the coating material is further laminated onto the outer peripheral surface of the honeycomb structure. The outer peripheral wall may be extruded integrally with the honeycomb structure portion and fired as it is, and may be used as the outer peripheral wall without any processing of the outer periphery.

The honeycomb structure is not limited to an integrated honeycomb structure with which the partition wall 11 is integrally formed. It may be, for example, a honeycomb structure (joined honeycomb structure) having a structure where a plurality of pillar shaped honeycomb segments each having a ceramic partition wall and a plurality of cells defined by the partition wall to form fluid flow paths are combined via joining material layers.

The honeycomb structure may further include a magnetic material. The providing of the honeycomb structure with the magnetic material may be carried out by any method. For example, the magnetic material may be included in: (1) a coating layer provided on the surface of at least one of the outer peripheral wall 10 and the partition wall 11; (2) plugged portions that plug the cells 11a on at least one and other end faces of the honeycomb structure; (3) a structure filled in the cells 11a; and/or (4) an annular body embedded in a groove provided on at least one and other end faces of the honeycomb structure.

As the magnetic material, for example, a plate-shaped, rod-shaped, ring-shaped, wire-shaped or fibrous magnetic material can be used. In the present invention, the rod-shaped magnetic material and the wire-shaped magnetic material are classified into a rod-shaped magnetic material if the diameter of the cross section perpendicular to the length direction is 0.8 mm or more, and a wire-shaped magnetic material if it is less than 0.8 mm.

When filling the cells 11a with the magnetic material or when plugging the cells 11a, the magnetic materials having those shapes can be used as appropriate depending on the shape of the cells 11a. A plurality of magnetic materials may be collectively filled in one cell 11a, or only one magnetic material may be filled in one cell 11a.

When the magnetic material is provided as the coating layer, the coating layer includes a fixing material in which powder of the magnetic material is dispersed. The fixing material that can be used herein includes glass, crystallized glass and ceramics, which contain silicate, borate or borosilicate, or glass, crystallized glass and ceramics, which contain other oxides, and the like.

When the magnetic material is provided as a filling material, the magnetic material may be arranged in every other cell to form a staggered pattern with respect to the vertically and horizontally adjacent cells 11a, or may be arranged in every other two or more cells, such as in every other two cells or three cells, or may be continuously arranged. The number, arrangement, and the like of the cells 11a filled with the filling material of the magnetic material particles are not limited, and they can be appropriately designed as necessary. From the viewpoint of increasing the heating effect, it is preferable to increase the number of cells 11a filled with the filling material of the magnetic material particles, whereas from the viewpoint of reducing pressure loss, it is preferable to reduce the number as much as possible.

The filling material may be composed of a composition in which the magnetic material particles and a binding material or an adhesive material are combined. Examples of the binding material include materials based on a metal or glass. The adhesive material includes materials based on silica or alumina. In addition to the binding material or adhesive material, it may further contain an organic or inorganic substance. The filling material may be filled from one end face to the other end face over the entire honeycomb structure. Further, the filling material may be filled from one end face of the honeycomb structure to the middle of the cells 11a.

The types of the magnetic material are, for example, the balance Co—20% by mass of Fe; the balance Co—25% by mass of Ni—4% by mass of Fe; the balance Fe—15 to 35% by mass of Co; the balance Fe—17 Co—2% by mass of Cr—1% by mass of Mo; the balance Fe—49% by mass of Co—2% by mass of V; the balance Fe—18% by mass of Co—10% by mass of Cr—2% by mass of Mo—1% by mass of Al; the balance Fe—27% by mass of Co—1% by mass of Nb; the balance Fe—20% by mass of Co—1% by mass of Cr—2% by mass of V; the balance Fe—35% by mass of Co—1% by mass of Cr; pure cobalt; pure iron; electromagnetic soft iron; the balance Fe—0.1 to 0.5% by mass of Mn; the balance Fe—3% by mass of Si; the balance Fe—6.5% by mass of Si; the balance Fe—18% by mass of Cr; the balance Fe—16% by mass of Cr—8% by mass of Al; the balance Ni—13% by mass of Fe—5.3% by mass of Mo; the balance Fe—45% by mass of Ni; the balance Fe—10% by mass of Si—5% by mass of Al; the balance Fe—36% by mass of Ni; the balance Fe—45% by mass of Ni; the balance Fe—35% by mass of Cr; the balance Fe—13% by mass of Cr—2% by mass of Si; the balance Fe—20% by mass of Cr—2% by mass of Si—2% by mass of Mo; the balance Fe—20% by mass of Co—1% by mass of V; the balance Fe—13% by mass of Cr—2% by mass of Si; the balance Fe—17% by mass of Co—2% by mass of Cr—1% by mass of Mo, and the like.

### DESCRIPTION OF REFERENCE NUMERALS

1: heating object
2: induction heating coil unit
3: power supply circuit
20: induction heating coil
200: conductor
201: opposing surface
201a: parallel portion
205: opposing portion
206: back portion
21: end wall portion
210: annular wall
211: spaced wall
22: back wall
23: first intermediate wall
24: second intermediate wall
25: soft magnetic material
AL: axis line

1. An induction heating coil unit disposed around an outer periphery of a heating object or inserted into a hollow portion of the heating object, the induction heat coil unit being configured to be able to heat the heating object by induction heating,
wherein the induction heating coil unit comprises:
an induction heating coil wherein conductors are wound around a predetermined axis line; and
end wall portions made of a soft magnetic material, the end wall portions being disposed to cover at least a part of end portions on both sides of the induction heating coil in an axial direction, and
wherein each of the conductors has an opposing surface opposing to an outer peripheral surface or an inner peripheral surface of the heating object, and
wherein the opposing surface comprises a parallel portion extending parallel to the axis line.

2. An induction heating coil unit disposed around an outer periphery of a heating object or inserted into a hollow portion of the heating object, the induction heat coil unit being configured to be able to heat the heating object by induction heating,
wherein the induction heating coil unit comprises:
an induction heating coil wherein conductors corresponding to at least one of (i) conductors each having corners in a cross section and (ii) conductors each having a flat cross section are wound around a predetermined axis line; and
end wall portions made of a soft magnetic material, the end wall portions being disposed so as to cover at least a part of end portions on both sides of the induction heating coil in an axial direction.

3. The induction heating coil unit according to claim 2,
wherein each of the conductors has an opposing surface opposing to an outer peripheral surface or an inner peripheral surface of the heating object, and
wherein the opposing surface comprises a parallel portion extending parallel to the axis line.

4. The induction heating coil unit according to claim 1, wherein a total extending width of the parallel portions in the extending direction of the axis line is at least half an extending width of the induction heating coil in the extending direction of the axis line.

5. The induction heating coil unit according to claim 1, wherein each of the end wall portions has a plurality of spaced walls spaced apart from each other in a circumferential direction of the induction heating coil.

6. The induction heating coil unit according to claim 1, wherein each of the end wall portions protrudes from an inner edge and an outer edge of each of the end portions in a direction orthogonal to the axis line.

7. The induction heating coil unit according to claim 1, wherein each of the conductors has a sheet shape having a thinner thickness in a direction orthogonal to the axis line than a width in the extending direction of the axis line, and the conductors are wound so as to be stacked in the direction orthogonal to the axis line.

8. The induction heating coil unit according to claim 1,
wherein the induction heating coil comprises: an opposing portion opposing to an outer peripheral surface or an inner peripheral surface of the heating object; and a back portion located on an opposite side of the opposing portion in the direction orthogonal to the axis, and
wherein the induction heating coil unit further comprises a back wall made of a soft magnetic material, the back wall being disposed to cover at least a part of the back portion of the induction heating coil.

9. The induction heating coil unit according to claim 1, further comprising a plurality of first intermediate walls made of a soft magnetic material, the first intermediate walls being spaced apart from each other in the extending direction of the axis line so as to be located between the conductors, and extending in the direction orthogonal to the axis line.

10. The induction heating coil unit according to claim 1, further comprising a plurality of second intermediate walls made of a soft magnetic material, the second intermediate walls being spaced apart from each other in the direction orthogonal to the axis line so as to be located between the conductors, and extending in the extending direction of the axis line.

11. The induction heating coil unit according to claim 1, wherein each of surfaces of the conductors is covered with a soft magnetic material.

12. The induction heating coil unit according to claim 1, wherein the soft magnetic material forming the end wall portions has a relative magnetic permeability of 5 or more.

13. The induction heating coil unit according to claim 1, wherein a distance between each of the end portions and each of the end wall portions of the induction heating coil in the extending direction of the axis line is less than or equal to 0.5 times a distance between the induction heating coil and a surface of the heating object in the direction orthogonal to the axis line.

14. The induction heating coil unit according to claim 1, wherein a thickness of each of the conductors in the direction orthogonal to the axis line is more than or equal to 0.5 times a skin depth of each of the conductors.

15. The induction heating coil unit according to claim 1, wherein a thickness of each of the conductors in the direction orthogonal to the axis line is more than or equal to 0.5 times and less than or equal to twice a skin depth of each of the conductors.

16. An induction heating device comprising:
the induction heating coil unit according to claim 1; and
a heating object wherein the induction heating coil unit is disposed on an outer periphery or inserted into an internal hollow portion of the heating object, the heating object being induction-heated by the induction heating coil unit.

17. The induction heating device according to claim 16, wherein the heating object is a honeycomb structure having a honeycomb structure portion comprising: an outer peripheral wall and a partition wall disposed on an inner side of the outer peripheral wall, the partition wall defining a plurality of cells, each of the cells extending from one end face to other end face to form a flow path.

18. The induction heating device according to claim 17, wherein the honeycomb structure further comprises magnetic material particles.
